(19) United States
(12) Patent Application Publication
(10) Pub. No.: US 2008/0158076 A1
(43) Pub. Date: Jul. 3, 2008

(54) Dynamically adjustable narrow bandwidth antenna for wide band systems

(75) Inventor: John Walley, Ladera Ranch, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 11/796,842

(22) Filed: Apr. 30, 2007

Related U.S. Application Data
(60) Provisional application No. 60/877,988, filed on Dec. 28, 2006.

(51) Int. Cl. H01Q 9/00

(52) U.S. Cl. 343/745

(57) ABSTRACT

The effective bandwidth of a dynamically adjustable antenna with a narrow natural bandwidth delineated by a first frequency change can be moved from the natural bandwidth to another narrow bandwidth of interest within a wide band spectrum using a tuning circuit. The tuning circuit controllably changes an effective impedance of the antenna to tune the antenna to the bandwidth of interest. During operation, the signal strength of a received signal within the bandwidth of interest is measured, and the resulting signal strength measurements are used by a processor to adjust the tuning circuit, thereby tuning the antenna to a desired center frequency within the bandwidth of interest.

### CROSS REFERENCE To RELATED APPLICATIONS

This U.S. Application for Patent claims the benefit of the filing date of U.S. Provisional Patent Application entitled, Dynamic Narrow Band Antenna for Wide Band Systems, Attorney Docket No. BP5780, having Ser. No. 60/877,988, filed on Dec. 28, 2006, which is incorporated herein by reference for all purposes.

### BACKGROUND

1. Technical Field

The present invention relates to antennas for use in wireless systems and, more particularly, to narrow band antennas for use in wide band systems.

2. Related Art

An antenna is an arrangement of aerial electrical conductors designed to transmit and/or receive radio signals. In its simplest form, an antenna typically includes an elongated portion of appreciable electrical length (i.e., the physical length of a wire or other conductor divided by its velocity factor). An electromagnetic wave impinging on the antenna induces a small voltage in the antenna, dependent upon on the frequency of the electromagnetic wave and the electrical length of the antenna. More particularly, the electrical length of the antenna determines the frequency range over which the antenna is effective, i.e., the range of frequencies that induces a voltage in the antenna. The frequency range of an antenna is commonly referred to as the antenna bandwidth. In addition, the frequency at which the induced voltage is greatest is commonly referred to as the resonant frequency or center frequency of the antenna.

In radio receivers, the electrical length of an antenna is typically chosen to be one-quarter wavelength (or a multiple of one-quarter wavelength) of the radio signal of interest to minimize the mismatch between the impedance of the antenna and the impedance of the radio receiver, thereby maximizing the power of the radio signal absorbed at the radio receiver. In addition, the antenna length is also selected to gather more of the radio signal energy. Therefore, antennas designed for longer wavelength (lower frequency) radio signals typically have a longer electrical length than antennas designed for shorter wavelength (higher frequency) radio signals. For example, cellular telephone antennas that are designed to operate at frequencies in the MHz range are typically shorter than FM radio antennas designed to operate at frequencies in the kHz range.

Currently, there is a trend towards enabling cellular telephone and other small, handheld devices to provide many other functions beyond voice communications, such as reception of FM radio broadcasts. However, due to the different frequency ranges (bands of the electromagnetic spectrum) assigned to traditional cellular communications and FM broadcast radio, and the fact that wide band antennas typically suffer from lower efficiency, poorer interference rejection, lower gain and a low Q (low antenna selectivity), different antennas are required to facilitate adequate reception of signals from each band, which is undesirable to cell phone users and unnecessarily increases the cost of such devices. Since low frequency antennas are generally longer than higher frequency antennas, such low frequency antennas may not fit into the small form factor of many handheld devices, such as cellular telephones and MP3 players.

Therefore, what is needed is an efficient antenna design that is capable of operating across a wide band spectrum and that is capable of fitting into the small form factor of many handheld devices.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a wireless system that includes a plurality of wireless devices;

FIG. 2 is a schematic block diagram illustrating a wireless device that includes a host device and an associated radio having a dynamic narrow band antenna, in accordance with embodiments of the present invention;

FIGS. 3A and 3B are schematic block diagrams illustrating exemplary radios providing dynamically adjustable narrow bandwidth antennas, in accordance with embodiments of the present invention;

FIG. 4 is a graph illustrating a plurality of frequency division and frequency modulated (FM) signals to which the antenna can be tuned in accordance with embodiments of the present invention;

FIG. 5 is a flowchart illustrating an exemplary process for dynamically adjusting the bandwidth and center frequency of a narrow bandwidth antenna to cover a wide band spectrum, in accordance with embodiments of the present invention;

FIG. 6 is a graph illustrating an exemplary adjustment range of a tuning circuit to tune the antenna to the carrier frequency of the FM signal of interest, in accordance with embodiments of the present invention;

FIG. 7 is a flow chart illustrating an exemplary process for tracking the carrier frequency of the FM signal of interest, in accordance with embodiments of the present invention; and

FIG. 8 is a graph illustrating an exemplary tracking operation of the tuning circuit to track of the carrier frequency of the FM signal of interest, in accordance with embodiments of the present invention.

### DETAILED DESCRIPTION OF THE DRAWINGS

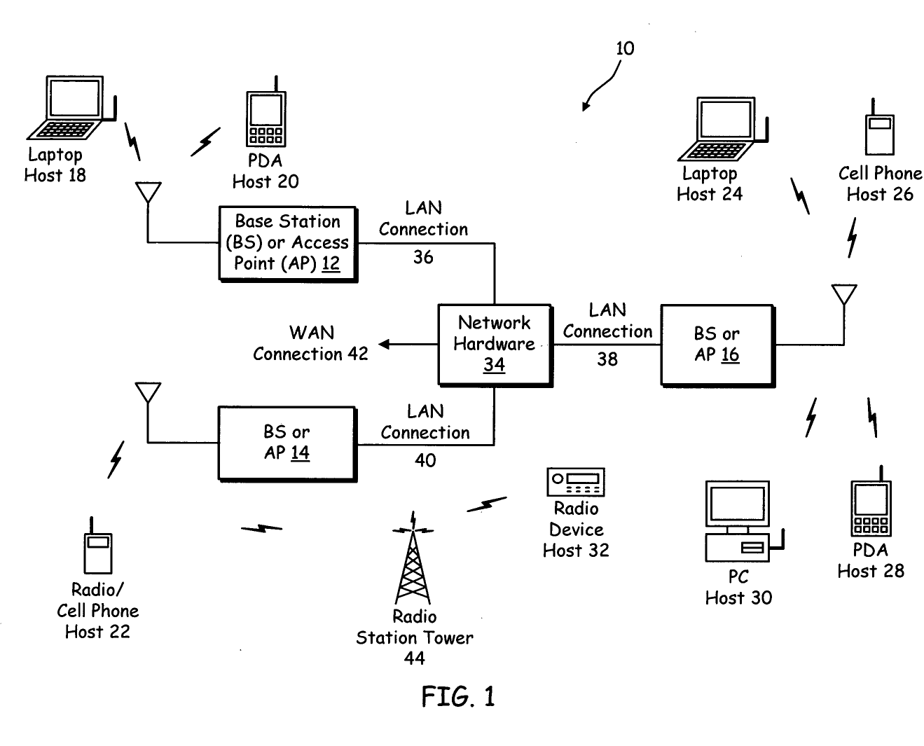

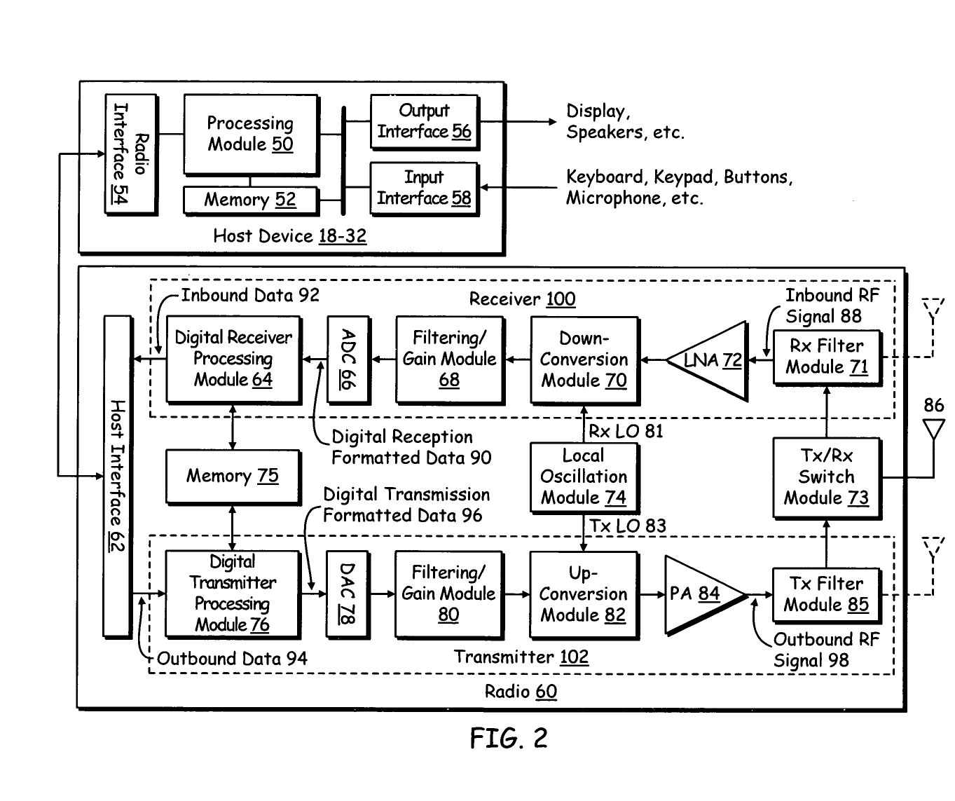

FIG. 1 is a functional block diagram illustrating an exemplary wireless system 10 that can be used in embodiments of the present invention. The wireless system shown in FIG. 1 includes a broadcast network containing a radio station broadcast tower 44 and a wireless communication network containing a plurality of base stations or access points 12-16 and a network hardware component 34. In addition, the wireless system 10 includes a plurality of wireless devices 18-32. The wireless devices 18-32 may be radio devices, such as radio device host 32, or communication devices, such as laptop host computers 18 and 24, personal digital assistant hosts 20 and 28, personal computer host 30 and/or cellular telephone host 26, or even a combination device, such as radio/cell phone host 32. Each of the radio devices 22 and 32 includes a radio receiver operable to receive a frequency modulated (FM) broadcast radio signal broadcast from the radio station broadcast tower 44. Each of the communication devices 18-30 includes a transceiver (transmitter and receiver) for communicating with a base station or access point 12-16. The details of the wireless devices will be described in greater detail with reference to FIG. 2.

Typically, base stations are used for cellular telephone networks and like-type networks, while access points are used for in-home or in-building wireless networks. For example, access points are typically used in Bluetooth systems. Regardless of the particular type of wireless communication network, the cellular telephone and the base station or access point 30 each include a built-in transceiver (transmitter and receiver) for modulating/demodulating information (data or speech) bits into a format that comports with the type of wireless communication network. There are a number of well-defined wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof) that could facilitate such wireless communication between the cellular telephone and a wireless communication network.

The base stations or access points 12-16 are operably coupled to the network hardware component 34 via local area network (LAN) connections 36, 38 and 40. The network hardware component 34, which may be a router, switch, bridge, modem, system controller, etc., provides a wide area network (WAN) connection 42 for the wireless communication network. Each of the base stations or access points 12-16 has an associated antenna or antenna array to communicate with the wireless communication devices in its area. Typically, the wireless communication devices 18-30 register with the particular base station or access points 12-16 to receive services from the wireless network. For direct connections (i.e., point-to-point communications), wireless communication devices communicate directly via an allocated channel. Although a network topology is shown in FIG. 1, it should be understood that the present invention is not limited to network topologies, and may be used in other environments, such as peer-to-peer, access point or mesh environments.

FIG. 2 is a schematic block diagram illustrating a wireless device that includes the host device 18-32 and an associated radio 60. For cellular telephone hosts and radio hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, a radio interface 54, an input interface 58 and an output interface 56. The processing module 50 and memory 52 execute the corresponding instructions that are typically done by the host device 18-32. For example, for a cellular telephone host device, the processing module 50 performs the corresponding communication functions in accordance with a particular cellular telephone standard.

The radio interface 54 allows data to be received from and/or sent to the radio 60. For data received from the radio 60 (e.g., inbound data), the radio interface 54 provides the data to the processing module 50 for further processing and/or routing to the output interface 56. The output interface 56 provides connectivity to an output device such as a display, monitor, speakers, etc., such that the received data may be displayed. The radio interface 54 also provides data from the processing module 50 to the radio 60. The processing module 50 may receive the outbound data from an input device, such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a receiver 100, a memory 75, a local oscillation module 74, and in embodiments in which the radio 60 is a transceiver, a transmitter 102 and an optional transmitter/receiver (Tx/Rx) switch module 73. The radio 60 further includes an antenna 86. In the transceiver shown in FIG. 2, the antenna 86 is shared by the transmit and receive paths as regulated by the Tx/Rx switch module 73. However, in other embodiments, the transmit and receive paths may use separate antennas.

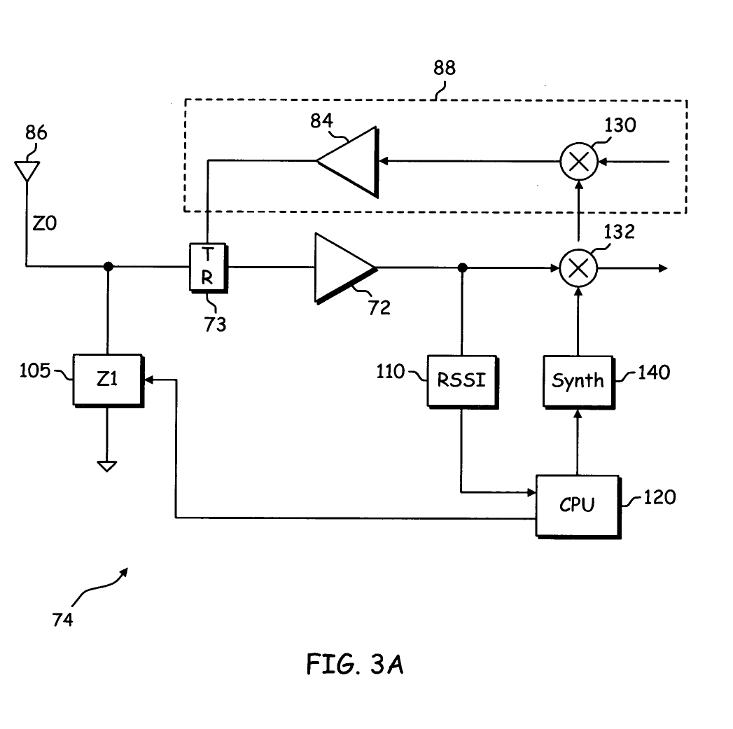

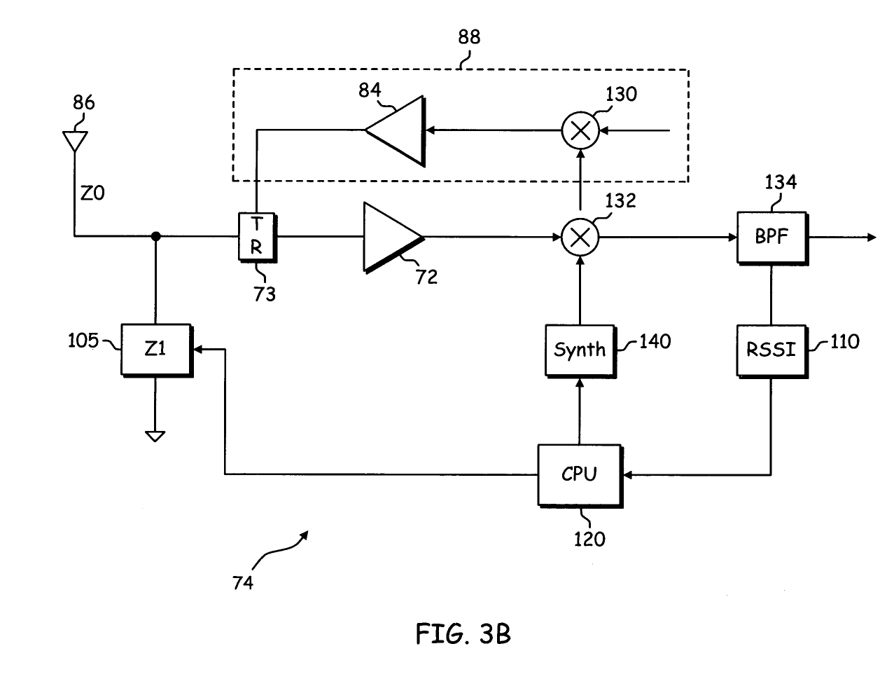

In accordance with embodiments of the present invention, the antenna 86 is a narrow bandwidth antenna that is dynamically adjustable to cover a wide band spectrum. As used herein, the term “narrow bandwidth” refers to bandwidths less than the entire “wide band spectrum” sought to be covered. For FM, the “wide band spectrum” covers frequencies within the range of 76 MHz and 108 MHz (i.e., has a bandwidth of 32 MHz), while the “narrow bandwidth” covers any frequency within that range and has a bandwidth between 100 kHz and 20 MHz. More specifically, the bandwidth and center (or resonant) frequency of the narrow bandwidth antenna are dynamically adjustable to cover only one channel (or carrier frequency) of interest at a time, thus increasing the antenna efficiency. An exemplary implementation of the dynamically adjustable narrow bandwidth antenna will be discussed below in connection with FIG. 3.

The receiver 100 includes a digital receiver processing module 64, an analog-to-digital converter 66, a filtering/gain module 68, a down-conversion module 70, a low noise amplifier 72 and a receiver filter module 71. The transmitter 102 includes a digital transmitter processing module 76, a digital-to-analog converter 78, a filtering/gain module 80, an IF mixing up-conversion module 82, a power amplifier 84 and a transmitter filter module 85.

The digital receiver processing module 64 and the digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and/or modulation. The digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the digital receiver processing module 64 and/or the digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and the digital receiver processing module 64 and/or the digital transmitter processing module 76 executes, operational instructions corresponding to at least some of the functions illustrated herein.

In an exemplary operation of the receiver 100, when the radio 60 receives an inbound frequency modulated (FM) signal 88 having a particular bandwidth and carrier frequency tuned to by the antenna 86, which was transmitted by a base station, an access point, or another wireless communication device, the antenna 86 provides the inbound RF signal 88 to the receiver filter module 71 via the Tx/Rx switch module 73. The Rx filter module 71 bandpass filters the inbound RF signal 88 and provides the filtered RF signal to low noise amplifier 72, which amplifies the inbound RF signal 88 to produce an amplified inbound RF signal. The low noise amplifier 72 provides the amplified inbound RF signal to the down-conversion module 70, which directly converts the amplified inbound RF signal into an inbound low IF signal (e.g., at 200 kHz IF) based on a receiver local oscillation 81 provided by local oscillation module 74. The down-conversion module 70 provides the inbound low IF signal to the filtering/gain module 68.

The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92. The host interface 62 provides the recaptured inbound data 92 to the host device 18-32 via the radio interface 54.

In an exemplary operation of the transmitter 102, when the radio 60 receives outbound data 94 from the host device 18-32 via the host interface 62, the host interface 62 routes the outbound data 94 to the digital transmitter processing module 76. The digital transmitter processing module 76 processes the outbound data 94 in accordance with a particular wireless communication standard (e.g., IEEE 802.11a, IEEE 802.11b, Bluetooth, etc.) to produce digital transmission formatted data 96. The digital-to-analog converter 78 converts the digital transmission formatted data 96 from the digital domain to the analog domain. The filtering/gain module 80 filters and/or adjusts the gain of the analog low IF signal prior to providing it to the up-conversion module 82. The up-conversion module 82 directly converts the analog low IF signal into an RF signal based on a transmitter local oscillation 83 provided by local oscillation module 74. The power amplifier 84 amplifies the RF signal to produce an outbound RF signal 98, which is filtered by the transmitter filter module 85. The antenna 86 transmits the outbound RF signal 98 to a targeted device, such as a base station, an access point and/or another wireless communication device.

As one of average skill in the art will appreciate, the wireless device of FIG. 2 may be implemented using one or more integrated circuits. For example, the host device 18-32 may be implemented on a first integrated circuit, while the digital receiver processing module 64, memory 75 and/or the digital transmitter processing module 76 may be implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device 18-32 and the digital receiver processing module 64 and/or the digital transmitter processing module 76 may be a common processing device implemented on a single integrated circuit. Further, memory 52 and memory 75 may be implemented on a single integrated circuit and/or on the same integrated circuit as the common processing modules of processing module 50, the digital receiver processing module 64, and/or the digital transmitter processing module 76.

FIGS. 3A and 3B are schematic block diagrams illustrating exemplary radios providing dynamically adjustable narrow bandwidth antennas 86, in accordance with embodiments of the present invention. The antenna 86 in both FIGS. 3A and 3B is shown coupled to a radio receiver 100 along a receiver path containing the T/R switch 73, low noise amplifier (LNA) 72, mixer 132 and synthesizer 140, and coupled to an optional radio transmitter 102 along a transmitter path containing a mixer 130, the synthesizer 140 power amplifier (PA) 84 and T/R switch 73. The dynamically adjustable narrow bandwidth antenna 86 operates with the radio receiver 100 to dynamically move to a carrier frequency for a signal (e.g., channel) of interest by adjusting the bandwidth and resonant (or center) frequency of the antenna 86. In an exemplary embodiment, the receiver 100 is an FM broadcast radio receiver capable of receiving FM broadcast signals from FM broadcast stations. In another embodiment, the receiver 100 is a communications receiver operating in a wireless communications network. In yet another embodiment, the receiver 100 is a dual-mode FM broadcast and communications receiver.

The dynamically adjustable narrow bandwidth antenna 86 of FIGS. 3A and 3B has a natural center frequency within a natural bandwidth covering a frequency range fₘᵢₙ to fₘₐₓ, which is sufficiently narrow such that the natural bandwidth (fₘₐₓ−fₘᵢₙ) is greater than the bandwidth of interest, but less than the entire “wide bandwidth” spectrum for which coverage is desired. Narrow bandwidth antennas can be constructed so that they have higher antenna efficiency, a higher Q (higher energy efficiency), better interference rejection capabilities and a higher gain than wide bandwidth antennas (i.e., antennas with bandwidths exceeding 1 MHz). However, as the name implies, a narrow bandwidth antenna is only effective over a narrow frequency range. Therefore, in accordance with embodiments of the present invention, in order to provide a narrow bandwidth antenna that is effective over the desired wide bandwidth spectrum (e.g., over a frequency range between 76 and 108 MHz), a tuning circuit 105 is coupled to the antenna 86 to adjust the effective center frequency or bandwidth of the antenna 86 from the natural bandwidth of the antenna to a particular bandwidth of interest.

For example, assuming that the natural center frequency of the antenna is 80.5 MHz and the natural bandwidth of the antenna is between 80 MHz and 81 MHz, but an inbound radio signal of interest (i.e., FM radio station 99.1 MHz) is within a bandwidth between 99 MHz and 100 MHz, the tuning circuit 105 is able to change the effective center frequency of the antenna from 80.5 MHz to 99.1 MHz, and the effective bandwidth of the antenna from between 80 and 81 MHz to between 99 and 100 MHz. The tuning circuit 105 moves the bandwidth and center frequency of the antenna 86 by changing the effective resonance or impedance Z0 of an antenna matching circuit (not specifically shown) including the antenna 86, thereby altering the effective electrical length of the antenna 86. In an exemplary embodiment, the tuning circuit 105 is a complex impedance Z1 that interacts with the antenna 86.

The tuning circuit 105 is controlled by a processor (CPU) 120. The CPU 120 may correspond to the receiver processing module 64 or may be a separate processing device, as described above in connection with FIG. 2. The CPU 120 selects (or is programmed to select) a particular bandwidth of interest within a wide band spectrum and center frequency for the antenna 86. The CPU 120 is coupled to the tuning circuit 105 to change the impedance Z1 of the tuning circuit 105, which in turn changes the effective impedance Z0 of the antenna 86. The CPU 120 makes adjustments to the impedance Z1 of the tuning circuit 105 based on measurements provided by a received signal strength indicator (RSSI) 110. The RSSI 110 is coupled to the receiver path to measure the signal strength of an inbound frequency modulated (FM) signal. The RSSI 110 produces signal strength measurements indicative of the measured signal strength of the inbound FM signal to the CPU 120 for use by the CPU 120 in adjusting the impedance Z1 of the tuning circuit 105.

In FIG. 3A, the RSSI 110 is coupled to the output of the LNA 72, while in FIG. 3B, the RSSI 110 is coupled to the output of a bandpass filter (BPF) 134 coupled to filter the output of the mixer 132. In the embodiment shown in FIG. 3A, the power input to the RSSI 110 from the LNA 72 includes all of the frequencies in the selected bandwidth of interest, and therefore, is most effective when the number of interfering signals in the selected bandwidth of interest is minimal. If there are interfering signals in the bandwidth of interest, the RSSI 110 can be moved to the output of the mixer 132 and BPF 134, as shown in FIG. 3B, so that the BPF 134 is tuned to the desired signal frequency, and as such, the RSSI 110 only measures the power of the desired signal frequency (channel of interest).

Although not shown, a second BPF and a second RSSI could be added to FIG. 3A or FIG. 3B to measure the RSSI when tuned to another signal, and the resulting RSSI measurements can be used to tune the antenna accordingly so that the desired signal is not attenuated. In addition, other tuning techniques could also be applied. For example, in FM broadcast systems, when the slope part of the antenna gain curve falls on top of the desired signal, the FM demodulator will produce an AM signal that will be a replica of the desired FM signal. Therefore, during tuning of the antenna, if an AM modulation signal appears on the carrier that matches the FM part of the carrier, the antenna can be tuned back.

Referring again to FIGS. 3A and 3B, in an exemplary operation, once the CPU 120 selects the particular bandwidth and center frequency for the antenna 86, the CPU 120 adjusts the impedance Z1 of the tuning circuit 105 to adjust the impedance Z0 of the antenna 86 until the bandwidth of the antenna 86 covers the bandwidth of interest. Thereafter, the CPU 120 programs the synthesizer 140 to the desired carrier frequency of the signal of interest. An inbound FM signal received at the antenna 86 within the bandwidth of interest is provided via the T/R switch 73 to the LNA 73 for amplification thereof. The amplified FM signal output by the LNA is coupled to the RSSI 110 either directly, as shown in FIG. 3A, or via the mixer 132 and BPF, as shown in FIG. 3B. The RSSI 110 measures the signal strength of the input signal.

Based on the signal strength measurements provided by the RSSI 110, the CPU 120 adjusts Z1, which effectively adjusts Z0, until the signal strength measurements are at a peak, indicating that the antenna 86 is tuned to the carrier frequency of the signal of interest (i.e., the resonant or center frequency of the antenna 86 is substantially equal to the carrier frequency of the signal of interest). For example, in one embodiment, the CPU 120 can perform a linear sweep of Z1 values or use a more sophisticated method to tune the antenna 86 to the carrier frequency of interest. Using the example above of a desired carrier frequency of 99.1 MHz, the CPU 120 operates to move Z1 until the center frequency of the antenna 86 is aligned with 99.1 MHz.

Once the RSSI of the received signal is at its peak, the impedance of the tuning circuit can be set to enable the antenna to continue to operate at the desired center frequency. However, in some embodiments, the narrow bandwidth antenna may be sensitive to small changes in the antenna impedance, such as the impedance change caused by someone's hand getting too close to the antenna. In this case, in one embodiment, the effective bandwidth of the antenna can be widened to reduce sensitivity to small impedance changes. For example, in one exemplary embodiment, the CPU 120 can operate to move Z1 to induce a complex impedance on the antenna matching unit of the antenna 86 (e.g., induce two resonances, one at a low frequency and one at a high frequency). In another exemplary embodiment, the antenna 86 can include multiple antennas, and the CPU 120 can operate to switch in one or more additional antennas to widen the effective bandwidth of the antenna 86. In yet another exemplary embodiment, the CPU 120 can operate to change the resistivity of the antenna matching circuit by switching in one or more resistances to widen the effective bandwidth of the antenna.

In another embodiment, to prevent and/or correct drift in the center frequency the center frequency of the antenna can be tracked. Tracking can be done by any available tracking algorithm. For example, in an exemplary embodiment, the CPU 120 executes a Tau Dither algorithm to move the value of Z1 slightly above and below the operating value of Z1, and measures the RSSI to determine whether Z1 should be adjusted. The dithering is done in small amounts so as to not hurt receiver performance, and to avoid generating audio artifacts (e.g., below the audio band) in an FM radio broadcast system.

The value of Z1 at each desired carrier frequency and the dither data obtained during tracking can be stored by the CP 120, in for example, memory 75, shown in FIG. 2, for subsequent use by the CPU 120. For example, when the antenna is tuned to 99.1 MHz, the impedance value of Z1 at 99.1 MHz can be stored and used by the CPU to estimate the proper setting of Z1 for another carrier frequency. By acquiring knowledge of the values of Z1 that correspond to different center frequencies of the antenna and also the dither data (first order derivatives), the CPU 120 can generate a map of the antenna center frequency verses Z1 to reduce re-acquisition times based upon past measurements. In a further embodiment, if the tracking performance of the antenna is not sufficient to adequately track the antenna movement, the bandwidth of the antenna 86 can be widened during tracking using the same type of impedance adjustments as before. The tracking can be performed using the same RSSI 110 that was used to initially acquire the center frequency or using another RSSI (not shown) in the path from the LNA to enable reading and adjusting without producing a drop in signal strength on the desired signal (channel).

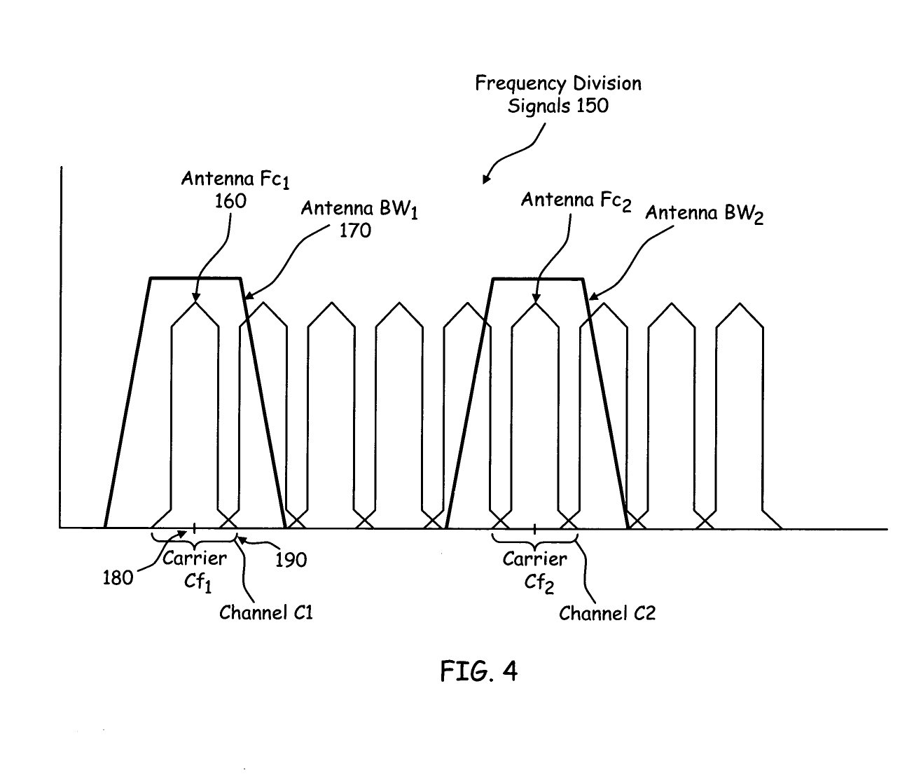

FIG. 4 is a graph illustrating a plurality of frequency division (FM) signals 150 to which the antenna can be tuned in accordance with embodiments of the present invention. As can be seen in FIG. 4, the bandwidth 170 of the antenna is narrow, covering only a single channel of interest 190. To maximize the performance of the antenna, the center frequency 160 of the antenna is tuned to a carrier frequency 180 of the channel of interest 190. The antenna can effectively be tuned to any carrier frequency of any channel of interest by adjusting the effective impedance of the antenna, as described above in connection with FIG. 3. For example, the antenna can easily and efficiently be tuned from a first center frequency (Fc1) of a first bandwidth (BW1) corresponding to a first carrier frequency (Cf1) of a first channel of interest (C1) to a second center frequency (Fc2) of a second bandwidth (BW2) corresponding to a second carrier frequency (Cf2) of a second channel of interest (C2) by changing the effective impedance of the antenna.

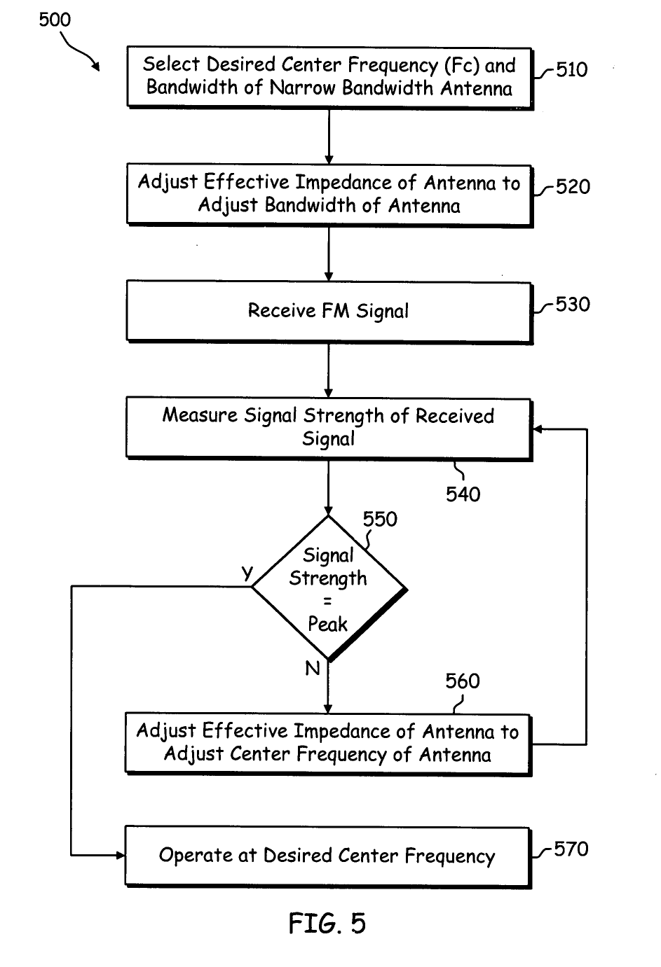

FIG. 5 is a flowchart illustrating an exemplary process 500 for dynamically adjusting the bandwidth and center frequency of a narrow bandwidth antenna to cover a wide band spectrum, in accordance with embodiments of the present invention. Initially, at block 510, a desired center frequency and bandwidth of the narrow bandwidth antenna are selected to cover a particular channel of interest. Once the center frequency and bandwidth of the antenna is adjusted to cover the channel of interest by adjusting the effective impedance of the antenna at block 520, an inbound signal including the channel of interest can be received by the antenna at block 530.

To tune the antenna to a carrier frequency of the channel of interest, at block 540, the signal strength of the received signal is measured. If the signal strength of the received signal is not at a peak value (N branch of block 550), the effective impedance of the antenna is again adjusted to adjust the center frequency of the antenna at block 560. Once the signal strength of the received signal is at its peak (Y branch of block 550), indicating that the center frequency of the antenna is tuned to the desired carrier frequency of the channel of interest, the antenna is operated at this center frequency and bandwidth.

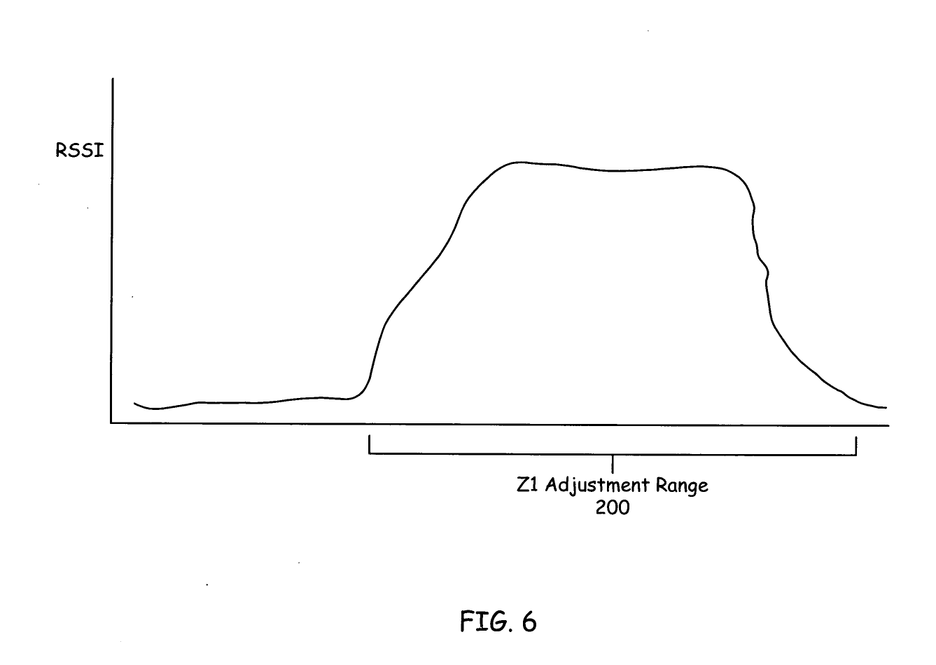

For example, as shown in FIG. 6, the impedance of the antenna can be adjusted by adjusting the impedance Z1 of the antenna tuning circuit (shown in FIG. 3) through a Z1 adjustment range 200. In the exemplary adjustment range shown in FIG. 6, if the value of Z1 is at the low end or high end of the adjustment range 200, the RSSI of the received signal will be low. However, if the value of Z1 is near the center of the Z1 adjustment range 200, the RSSI will be at its peak, indicating that the antenna is tuned to the carrier frequency of the FM signal of interest. Once the RSSI of the received signal is at its peak, the impedance of the tuning circuit can be set to the current operating value to enable the antenna to continue to operate at the desired center frequency.

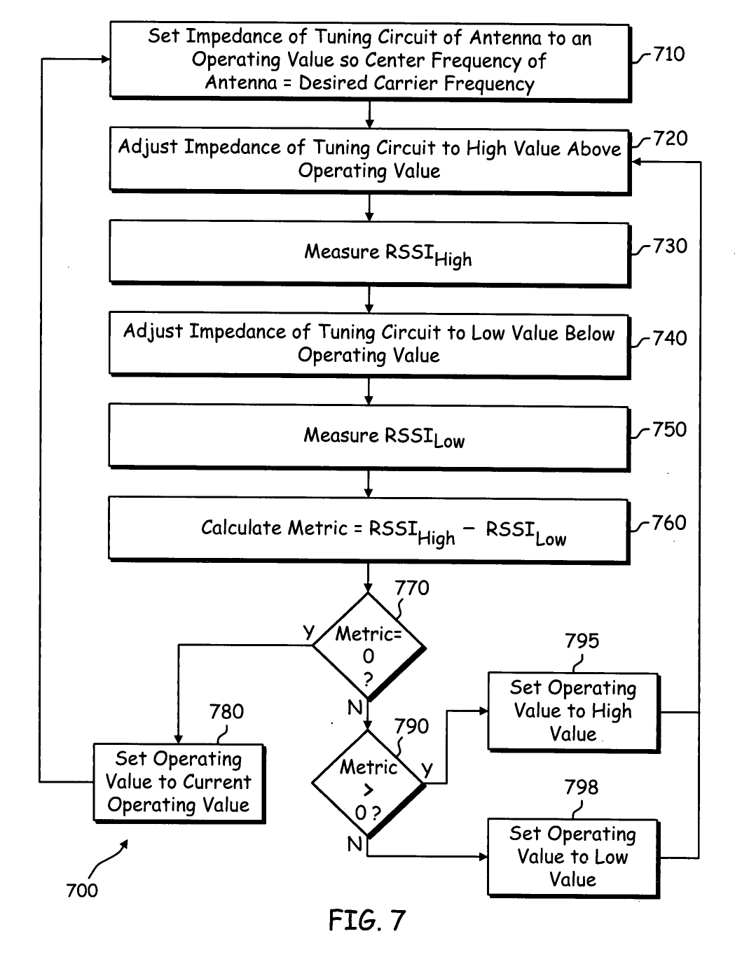

FIG. 7 is a flow chart illustrating an exemplary process 700 for tracking the carrier frequency of the FM signal of interest, in accordance with embodiments of the present invention. Initially, at block 710, the impedance of the tuning circuit of the antenna is set to an operating value at which the center frequency of the antenna is substantially equivalent to the carrier frequency of the signal of interest. To prevent and/or correct drifts in the center frequency of the antenna due to various unavoidable impedance changes in the antenna, the center frequency of the antenna can be tracked using, for example, a Tau Dither method.

In the Tau Dither method, at block 720, the impedance of the tuning circuit is first adjusted to a high value above the current operating value, and the received signal strength of the signal at the high impedance setting is measured (RSSI_{High}) at block 730. Thereafter, at block 740, the impedance of the tuning circuit is adjusted to a low value below the current operating value, and the received signal strength at the low impedance setting is measured (RSSI_{Low}) at block 750. Following the two RSSI measurements, a metric (|RSSI_{High}|−|RSSI_{Low}|) is calculated at bock 760. If the metric equals zero (Y branch of block 770), the antenna is properly tuned. Therefore, at block 780, the impedance operating value of the tuning circuit remains at the current operating value. This process continually repeats at block 710 to ensure the antenna remains properly tuned.

However, if the metric does not equal to zero (N branch of block 770), the impedance of the tuning circuit is adjusted slightly in the proper direction. For example, as shown in FIG. 7, if the metric is greater than zero (Y branch of block 790), the signal strength at the high impedance value is greater than the signal strength of the low impedance value, indicating that proper tuning of the antenna requires a higher impedance of the tuning circuit than the current impedance of the tuning circuit. Therefore, at block 795, for simplicity the impedance operating value of the tuning circuit is set to the high impedance value. It should be understood that block 795 covers any setting of the tuning circuit impedance that higher than the current operating value.

However, if the metric is less than zero (N branch of block 790), the signal strength at the low impedance value is greater than the signal strength of the high impedance value, indicating that proper tuning of the antenna requires a lower impedance of the tuning circuit than the current impedance of the tuning circuit. Therefore, at block 798, the impedance operating value of the tuning circuit is set to the low impedance value (or any value lower than the current operating value). This process repeats at block 720 until the antenna is properly tuned.

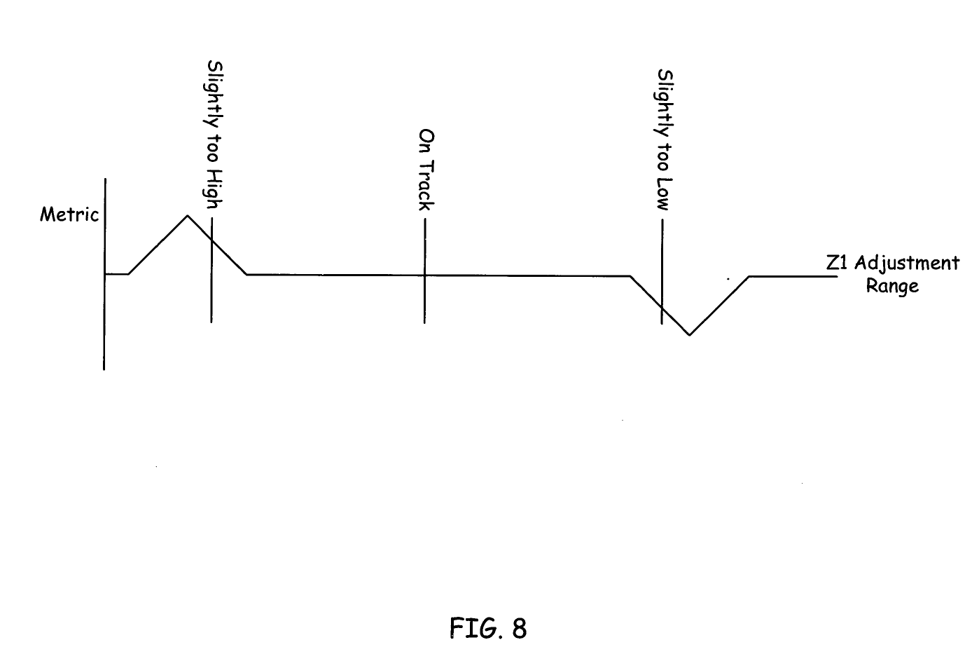

FIG. 8 is a graph illustrating an exemplary tracking operation of the tuning circuit to track of the carrier frequency of the FM signal of interest, in accordance with embodiments of the present invention. As can be seen in FIG. 8, if the metric is below zero (too low), the impedance of the tuning circuit (Z1) is too high and should be reduced. Likewise, if the metric is above zero (too high), the impedance of the tuning circuit (Z1) is too low and should be increased. When the metric equals zero, the impedance of the tuning circuit (Z1) is set to the correct value.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The preceding discussion has presented a dynamically adjustable narrow bandwidth antenna and method of operation thereof. As one of ordinary skill in the art will appreciate, other embodiments may be derived from the teaching of the present invention without deviating from the scope of the claims.

What is claimed is:

1. A receiver, comprising:
a dynamically adjustable antenna having a narrow natural bandwidth delineated by a first frequency range and coupled to receive a radio frequency signal within a narrow bandwidth of interest delineated by a second frequency range different from said first frequency range;
a tuning circuit coupled to said antenna to controllably move an effective bandwidth of said antenna from said narrow natural bandwidth to said narrow bandwidth of interest and to tune said antenna to a center frequency associated with said radio frequency signal within said narrow bandwidth of interest;
a low noise amplifier coupled to amplify said radio frequency signal and to produce an amplified signal;
a received signal strength indicator coupled to measure a signal strength of said amplified signal and to produce signal strength measurements indicative of said signal strength; and
a processor operable to select said center frequency within said bandwidth of interest from a wide band spectrum over which said receiver operates and coupled to adjust said tuning circuit based on said signal strength measurements.

2. The receiver of claim 1, wherein said tuning circuit controllably changes an effective impedance of said antenna to move said effective bandwidth of said antenna to said narrow bandwidth of interest and to tune said antenna to said center frequency within said narrow bandwidth of interest; and wherein said processor operates to adjust an impedance of said tuning circuit based on said signal strength measurements to controllably change said effective impedance of said antenna, thereby tuning said antenna to said center frequency within said bandwidth of interest.

3. The receiver of claim 2, wherein said radio frequency signal has a carrier frequency within said bandwidth of interest and said tuning circuit is coupled to said antenna to tune said center frequency of said antenna to said carrier frequency of said radio frequency signal.

4. The receiver of claim 3, wherein said processor operates to adjust said tuning circuit to tune said antenna to said carrier frequency within said bandwidth of interest based on said signal strength measurements.

5. The receiver of claim 4, wherein said processor operates to adjust said tuning circuit until said signal strength measurements indicate a peak in said signal strength at said carrier frequency and to set said impedance of said tuning circuit to an impedance value at which said antenna is tuned to said carrier frequency within said bandwidth of interest.

6. The receiver of claim 5, wherein said processor further operates to adjust said tuning circuit to track said carrier frequency during operation.

7. The receiver of claim 6, wherein said processor tracks said carrier frequency by executing a Tau Dither algorithm.

8. The receiver of claim 7, wherein said processor maintains dither data indicating changes in said impedance value of said tuning circuit during tracking of said carrier frequency.

9. The receiver of claim 8, wherein said processor maintains respective impedance values and respective dither data associated with said tuning circuit for a plurality of carrier frequencies and associated bandwidths of interest within said wide band spectrum.

10. The receiver of claim 9, wherein said processor uses said impedance values and said dither data to reduce re-acquisition times for said plurality of carrier frequencies.

11. The receiver of claim 5, wherein said processor uses said impedance value of said tuning circuit associated with said carrier frequency of said radio frequency signal to estimate another impedance value of said tuning circuit that causes said antenna to tune to a second carrier frequency within a second bandwidth of interest in said wide band spectrum.

12. The receiver of claim 5, further comprising:
a frequency synthesizer coupled to produce a reference signal programmed by said processor;
a mixer coupled to receive said amplified signal and said reference signal and operable to convert said amplified signal to a low intermediate frequency (IF) signal using said reference signal; and
a bandpass filter coupled to receive said low IF signal and operable to filter said low IF signal to produce a filtered signal; and wherein said received signal strength indicator is coupled to receive said filtered signal.

13. The receiver of claim 1, wherein said radio frequency signal is a broadcast radio signal.

14. The receiver of claim 1, wherein said radio frequency signal is a communications signal intended for said receiver.

15. The receiver of claim 14, wherein said receiver is integrated in a transceiver operating in a wide band communications network.

16. The receiver of claim 1, wherein said processor is further operable to adjust said tuning circuit to controllably widen or narrow said effective bandwidth of said antenna.

17. A method for dynamically adjusting an effective bandwidth of an antenna to cover a wide band spectrum, said antenna having a narrow natural bandwidth delineated by a first frequency range, said method comprising:
selecting a center frequency within a narrow bandwidth of interest within said wide band spectrum;
controllably moving said effective bandwidth of said antenna from said narrow natural bandwidth to said narrow bandwidth of interest, said narrow bandwidth of interest having a second frequency range different from said first frequency range;
receiving at said antenna a radio frequency signal within said bandwidth of interest;
amplifying said radio frequency signal to produce an amplified signal;
measuring a signal strength of said amplified signal to produce signal strength measurements indicative of said signal strength; and
repeating said controllably moving said effective bandwidth of said antenna based on said signal strength measurements to tune said antenna to said center frequency within said bandwidth of interest.

18. The method of claim 17, wherein said controllably moving said effective bandwidth of said antenna further comprises:
controllably adjusting an effective impedance of said antenna to move said effective bandwidth of said antenna from said narrow natural bandwidth to said narrow bandwidth of interest.

19. The method of claim 18, wherein said radio frequency signal has a carrier frequency within said bandwidth of interest, and wherein said controllably adjusting said effective impedance of said antenna further comprises:
adjusting said effective impedance of said antenna to tune said center frequency of said antenna to said carrier frequency of said radio frequency signal based on said signal strength measurements.

20. The method of claim 19, wherein said controllably adjusting said effective impedance of said antenna further comprises:
adjusting said effective impedance until said signal strength measurements indicate a peak in said signal strength at said carrier frequency.

21. The method of claim 19, wherein said controllably adjusting said effective impedance of said antenna further comprises:
adjusting an impedance of a tuning circuit coupled to said antenna to controllably adjust said effective impedance of said antenna; and
setting said tuning circuit to an impedance value at which said antenna is operating at said carrier frequency.

22. The method of claim 21, wherein said setting further comprises:
adjusting said impedance value of said tuning circuit to track said carrier frequency during operation.

23. The method of claim 22, further comprising:
maintaining dither data indicating changes in said impedance value of said tuning circuit during tracking of said carrier frequency.

24. The method of claim 23, wherein said maintaining further comprises:
maintaining respective impedance values and respective dither data for a plurality of carrier frequencies within respective bandwidths of interest in said wide band spectrum.

25. The method of claim 24, further comprising:
using said impedance values and said dither data to reduce re-acquisition times for said plurality of carrier frequencies.

26. The method of claim 21, further comprising:
estimating another impedance value of said tuning circuit that causes said antenna to tune to a second carrier frequency within a second bandwidth of interest in said wide band spectrum from said impedance value of said tuning circuit that causes said antenna to tune to said carrier frequency of said radio frequency signal.
